(19) United States
(12) Patent Application Publication
(10) Pub. No.: US 2011/0158267 A1
(43) Pub. Date: Jun. 30, 2011

(54) Pulsed laser system with a thulium-doped saturable absorber Q-switch

(75) Inventor: Tzong-Yow Tsai, Tainan City (TW)

(73) Assignee: National Cheng Kung University, Tainan City (TW)

(21) Appl. No.: 12/929,054

(22) Filed: Dec. 27, 2010

(30) Foreign Application Priority Data
Dec. 31, 2009 (TW) 098146344

(51) Int. Cl. H01S 3/113

(52) U.S. Cl. 372/11

(57) ABSTRACT

A pulsed laser system having a Tm³⁺-doped saturable absorber Q-switch unit, capable of outputting laser pulses sequentially by inputting a stable continuous-wave pump light source, is disclosed. When the gain excited in the Er³⁺ laser resonator exceeds the lasing threshold, the photons start resonating and being amplified in the Er³⁺ laser resonator. At the same moment, the Tm³⁺-doped saturable absorber Q-switch unit absorbs the resonant photons and quickly reaches the situation of absorption saturation. Then, sequentially Q-switched Er³⁺ laser pulses at 1570 nm are passively produced. In addition, the Tm³⁺-doped saturable absorber Q-switch unit can be designated as the gain material of a second laser resonator for producing a gain-switched Tm³⁺ laser pulse at 1950 nm after each of the Q-switched Er³⁺ laser pulses. Moreover, the Tm³⁺ and Ho³⁺ co-doped crystal can be designated as the saturable absorber Q-switch unit, for producing a gain-switched Ho³⁺ laser pulses at 2090 nm.

### BACKGROUND OF THE INVENTION

1. Field of the Invention

The present invention relates to a pulsed laser system having a Tm³⁺-doped saturable absorber Q-switch unit, especially to a pulsed laser system having a Tm³⁺-doped saturable absorber Q-switch unit that is capable of outputting laser pulses sequentially by inputting a stable continuous-wave pump light source into the laser resonator thereof.

2. Description of Related Art

The technique of all-fiber Q-switched laser can be divided into two categories: passive type and active type. Unlike an actively Q-switched all-fiber laser requiring a driver to control the operation of the Q-switch, a passively Q-switched all-fiber laser can produce nanosecond pulses repeatedly and automatically, simply with a saturable absorption Q-switch (SAQS) fiber positioned in the resonator. However, only a few SAQS fibers have been demonstrated in the literature, and most are for ytterbium-doped fiber lasers, like Tm³⁺, Sm³⁺, Ho³⁺, Bi doped fibers for Q-switching ytterbium fiber lasers at the wavelengths of 1055-1090, 1085, 1050-1160 and 1125 nm, respectively, where the Yb³⁺ fiber has a relatively small emission cross section, σₑ.

Besides, the Er³⁺-doped fiber is the most applicable material in the optical communication field that has been widely employed in optical amplifiers for signal amplification. However, because of the high stimulated emission cross section factor (σₑ) of Er³⁺-doped fiber, it is difficult to find a fiber-type SAQS to realize a passively Q-switched all-fiber Er³⁺ laser. According to the physics of saturable-absorber Q-switching, the absorption cross section factor (σₐ) of the SAQS material must be higher than the stimulated emission cross section factor (σₑ) of the Er³⁺-doped gain fiber. And the known crystals fitting the criteria (σₐ>σₑ) are U:CaF2, Co:ZnS and Co:ZnSe, etc. that are not available in fiber formation.

Moreover, since Er³⁺-doped fiber has close values of the σₐ and σₑ in the range of 1.5-1.6 μm, an Er³⁺-doped all-fiber laser Q-switched by an Er³⁺-doped fiber can be achieved in some special resonator structures, like a ring resonator with an Er SAQS fiber in an intensity-enhanced section, or a resonator with mode-field-area mismatch between the gain fiber and the SAQS fiber.

Therefore, a directly pulsed laser system having a Tm³⁺-doped saturable absorber Q-switch, capable of outputting laser pulses sequentially by inputting a stable continuous-wave pump light source into the laser resonator thereof is required in the industry.

### SUMMARY OF THE INVENTION

The object of the present invention is to provide a pulsed laser system having a Tm³⁺-doped saturable absorber Q-switch unit that can successively produce Q-switched pulses while being pumped with a stable continuous-wave light source.

The other object of the present invention is to provide a pulsed laser system having a Tm³⁺-doped saturable absorber Q-switch unit that can successively produce gain-switched pulses while being pumped with a stable continuous-wave light source.

To accomplish the object, the pulsed laser system having a Tm³⁺-doped saturable absorber Q-switch unit of the present invention comprising: a first laser resonator including a first reflective component, a second reflective component, with a first gain unit and a Tm³⁺-doped saturable absorber Q-switch unit, the first gain unit and the Tm³⁺-doped saturable absorber Q-switch unit located between the first reflective unit and the second reflective unit; and a pump light source unit, located on one side of the first laser resonator and providing a pump light source into the first laser resonator; wherein, while the pump light source is incident into the first laser resonator, the first gain unit is excited to reach a gain, when the gain of the first gain unit exceeds the lasing threshold, the resonant photons are generated and being amplified inside the first laser resonator, the Tm³⁺-doped saturable absorber Q-switch unit absorbs the resonant photons till the Tm³⁺-doped saturable absorber Q-switch unit reaches the situation of absorption saturation; a laser pulse is formed from the resonant photons and outputted from the first laser resonator.

To accomplish the object, the pulsed laser system having a Tm³⁺-doped saturable absorber Q-switch unit of the present invention comprising: a first laser resonator including a first reflective component, a second reflective component, a first gain unit and a Tm³⁺-doped saturable absorber Q-switch unit, with the first gain unit and the Tm³⁺-doped saturable absorber Q-switch unit located between the first reflective unit and the second reflective unit; a second laser resonator including a third reflective component, a fourth reflective component and a second gain unit, the second gain unit is located between the first reflective component and the second reflective component, and between the third reflective component and the fourth reflective component; and a pump light source unit located on one side of the first laser resonator and providing a pump light source into the first laser resonator; wherein, while the pump light source is incident into the first laser resonator, the first gain unit is excited to reach a gain, when the gain of the first gain unit exceeds the lasing threshold of the first laser resonator, the first resonant photons are generated and amplified inside the first laser resonator, the Tm³⁺-doped saturable absorber Q-switch unit absorbs the first resonant photons till the Tm³⁺-doped saturable absorber Q-switch unit reaches the situation of absorption saturation; a first laser pulse is formed from the first resonant photons and outputted from the first laser resonator; the second gain unit is excited by the first resonant photons and reaches a gain, and when the gain of the second gain unit exceeds the lasing threshold of the second laser resonator, the second resonant photons are generated and amplified inside the second laser resonator, a second laser pulse is formed from the second resonant photons and outputted from the second laser resonator. (This is called a gain-switched pulse.)

To accomplish the object, the pulsed laser system having a Tm³⁺-doped saturable absorber Q-switch unit of the present invention comprising: a first laser resonator including a first reflective component, a second reflective component, a first gain unit and a Tm³⁺-doped saturable absorber Q-switch unit, with the first gain unit and the Tm³⁺-doped saturable absorber Q-switch unit located between the first reflective unit and the second reflective unit; a second laser resonator including a third reflective component and a fourth reflective component, the Tm³⁺-doped saturable absorber Q-switch unit is located between the third reflective component and the fourth reflective component, the Tm³⁺-doped saturable absorber Q-switch unit is functioning as a gain unit in the second laser resonator; and a pump light source unit located on one side of the first laser resonator and providing a pump light source into the first laser resonator; wherein, while the pump light source is incident into the first laser resonator, the first gain unit is excited to reach a gain, when the gain of the first gain unit exceeds the lasing threshold of the first laser resonator, the first resonant photons are generated and amplified inside the first laser resonator, the Tm³⁺-doped saturable absorber Q-switch unit absorbs the first resonant photons till the Tm³⁺-doped saturable absorber Q-switch unit reaches the situation of absorption saturation; a first laser pulse is formed from the first resonant photons and outputted from the first laser resonator; the Tm³⁺-doped saturable absorber Q-switch unit is also exited by the first resonant photons and reaches a gain, and when the gain of the Tm³⁺-doped saturable absorber Q-switch unit exceeds the lasing threshold of the second laser resonator, the second resonant photons are generated and amplified inside the second laser resonator, a second laser pulse is formed from the second resonant photons and outputted from the second laser resonator.

Therefore, due to the first laser resonator of the pulsed laser system having a Tm³⁺-doped saturable absorber Q-switch unit of the present invention comprises a Tm³⁺-doped saturable absorber Q-switch unit, and the Q-switching criterion is satisfied by the properties of the first gain unit and the Tm³⁺-doped saturable absorber Q-switch unit at the resonant wavelength of the first laser resonator determined by the first and the second reflective units, the pulsed laser system having a Tm³⁺-doped saturable absorber Q-switch unit of the present invention can successively produce Q-switched pulses while being pumped with a stable continuous-wave light source.

Besides, due to the first resonant photon generated in the first laser resonator can excite the second gain unit of the second laser resonator and make the second gain unit to reach a gain, thus, the pulsed laser system having a Tm³⁺-doped saturable absorber Q-switch unit of the present invention can successively produce gain-switched pulses while being pumped with a stable continuous-wave light source.

### BRIEF DESCRIPTION OF THE DRAWINGS

FIG. 1 is a perspective view of the pulsed laser system having a Tm³⁺-doped saturable absorber Q-switch unit according to the first embodiment of the present invention.

FIG. 2 is a perspective view of the pulsed laser system having a Tm³⁺-doped saturable absorber Q-switch unit according to the second embodiment of the present invention.

FIG. 3 is a perspective view of the pulsed laser system having a Tm³⁺-doped saturable absorber Q-switch unit according to the third embodiment of the present invention.

FIG. 4 is a perspective view of the pulsed laser system having a Tm³⁺-doped saturable absorber Q-switch unit according to the fourth embodiment of the present invention.

FIG. 5 is a perspective view of the pulsed laser system having a Tm³⁺-doped saturable absorber Q-switch unit according to the fifth embodiment of the present invention.

FIG. 6 is a perspective view of the pulsed laser system having a Tm³⁺-doped saturable absorber Q-switch unit according to the sixth embodiment of the present invention.

FIG. 7 is a perspective view of the pulsed laser system having a Tm³⁺-doped saturable absorber Q-switch unit according to the seventh embodiment of the present invention.

### DETAILED DESCRIPTION OF THE PREFERRED EMBODIMENT

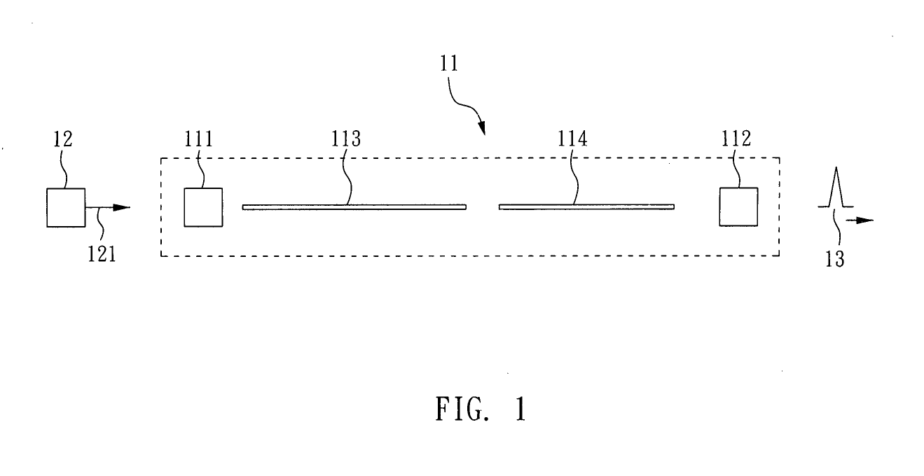

With reference to FIG. 1, which is a perspective view of the pulsed laser system having a Tm³⁺-doped saturable absorber Q-switch unit according to the first embodiment of the present invention. As shown in FIG. 1, the pulsed laser system having a Tm³⁺-doped saturable absorber Q-switch unit according to the first embodiment of the present invention comprises: a first laser resonator 11 and a pump light source unit 12. Wherein, the first laser resonator 11 includes a first reflective component 111, a second reflective component 112, a first gain unit 113 and a Tm³⁺-doped saturable absorber Q-switch unit 114. The pump light source unit 12 is located on one side of the first laser resonator 11, for providing a pump light source 121 into the first laser resonator 11.

Besides, as shown in FIG. 1, in the first laser resonator 11, the first gain unit 113 and the Tm³⁺-doped saturable absorber Q-switch unit 114 are located between the first reflective component 111 and the second reflective component 112, so that the resonant photons (not shown in the figure) of the first laser resonator 11 could pass through the first gain unit 113 and the Tm³⁺-doped saturable absorber Q-switch unit 114 repeatedly. Moreover, the pulsed laser system having a Tm³⁺-doped saturable absorber Q-switch unit according to the first embodiment of the present invention operating, is excited with the pump light source unit 12 emitting the pump light source 121 to create a gain in the first gain unit 113.

While being excited, the gain of the first gain unit 113 increases with time, and when the gain of the first gain unit 113 exceeds the lasing threshold, the resonant photons (not shown in the figure) are generated and being amplified inside the first laser resonator 11. At this moment, the Tm³⁺-doped saturable absorber Q-switch unit 114 of the first laser resonator 11 absorbs the resonant photons (not shown in the figure) till the Tm³⁺-doped saturable absorber Q-switch unit 114 reaches the situation of absorption saturation (i.e. the Tm³⁺-doped saturable absorber Q-switch unit 114 becomes transparent, or called bleached). Then, a laser pulse 13 is formed from the resonant photons (not shown in the figure) and outputted from the first laser resonator 11.

In the present embodiment, the pump light source unit 12 is a laser diode, capable of providing a stable continuous-wave pump light source 121 with, and the wavelength of the pump light source 121 is around 980 nm. Besides, the first gain unit 113 is an Er³⁺-doped fiber, and the Tm³⁺-doped saturable absorber Q-switch unit 114 is a Tm³⁺-doped fiber. The first reflective component 111 is a fiber Bragg grating component with a high reflectivity (about 100%) and the reflective wavelength thereof is 1570 nm. The second reflective component 112 is also a fiber Bragg grating component, but with a low reflectivity (about 20%) and the reflective wavelength thereof is 1570 nm.

As mentioned above, in the present embodiment, while the pump light source 121 is incident into the first laser resonator 11, the first gain unit 113 is excited to reach a gain.

When the gain of the Er³⁺-doped fiber, which is designated as the first gain unit 113, exceeds the lasing threshold of the first laser resonator 11, the resonant photons at the wavelength of 1570 nm are generated and amplified inside the first laser resonator 11. At this moment, the Tm³⁺ ion of the Tm³⁺-doped fiber, which is designated as the Tm³⁺-doped fiber saturable absorber Q-switch unit 114, absorbs the resonant photons (not shown in the figure) and the energy level of the Tm³⁺ ion is raised from the original ³H₆ level to the ³F₄ level. When the Tm³⁺-doped saturable absorber Q-switch unit 114 reaches the situation of absorption saturation (i.e. the Tm³⁺-doped saturable absorber Q-switch unit 114 becomes transparent at the wavelength of 1570 nm), the resonant photons (not shown in the figure) are amplified rapidly. Then, a laser pulse 13 at the wavelength of 1570 nm is formed and outputted from the first laser resonator 11.

It can be said that, before the appearance of the laser pulse 13, the first laser resonator 11 has initially a low Q factor due to the high absorption loss caused by the existence of the Tm³⁺-doped fiber as a Tm³⁺-doped saturable absorber Q-switch unit 114. However, once the Tm³⁺-doped fiber designated as a Tm³⁺-doped saturable absorber Q-switch unit 114 cannot absorb the resonant photons (not shown in the figure) anymore, the absorption loss of the first laser resonator 11 decreases as a result, the Q factor of the first laser resonator 11 switches from a low level to a high level. At this moment, these resonant photons are amplified rapidly, and the laser pulse 13 is formed.

As shown in FIG. 1, the laser pulse 13 is outputted from the second reflective unit 112 side of the first laser resonator 11 of the pulsed laser system having a Tm³⁺-doped saturable absorber Q-switch unit according to the first embodiment of the present invention. Afterward, after the laser pulse 13 is outputted, the Tm³⁺-doped saturable absorber Q-switch unit 114 instantly returns back to the initial condition in which the Tm³⁺-doped saturable absorber Q-switch unit 114 can absorb the resonant photons (not shown in the figure) once again. After that, Tm³⁺ doped fiber being designated as the Tm³⁺-doped saturable absorber Q-switch unit 114 repeats the aforementioned process (to reach an absorption saturation situation once again), making the pulsed laser system having a Tm³⁺-doped saturable absorber Q-switch unit according to the first embodiment of the present invention to output another laser pulse 13.

It should be noticed that, in the pulsed laser system having a Tm³⁺-doped saturable absorber Q-switch unit according to the first embodiment of the present invention, to enhance the gain property of first gain unit 113 (Er³⁺ doped fiber), the first gain unit 113 could be further co-doped with Yb³⁺ or other heterogeneous dopants. Besides, to enhance the saturation absorption property of the Tm³⁺-doped saturable absorber Q-switch unit 114, the Tm³⁺-doped saturable absorber Q-switch unit 114 could also be further co-doped with aluminum, phosphorous, or other heterogeneous dopants.

Moreover, since the emission wavelength band of the photons by the energy transition between the level ⁴I_{13/2} to the level ⁴I_{15/2} of the Er³⁺ ions of the Er³⁺ doped fiber (designated as the first gain unit 113), is from 1480 to 1620 nm, and the absorption wavelength band by the energy transition between the level ³H₆ to the level ³F₄ of the Tm³⁺ of the Tm³⁺-doped fiber (designated as the Tm³⁺-doped saturable absorber Q-switch unit 114), is from 1500 nm to 1900 nm, the operation wavelength range of the laser pulse 13 outputted by the pulsed laser system having a Tm³⁺-doped saturable absorber Q-switch unit according to the first embodiment of the present invention is between 1500 nm and 1620 nm. However, the preferred operation wavelength range of the laser pulse 13 is between 1570 nm and 1590 nm.

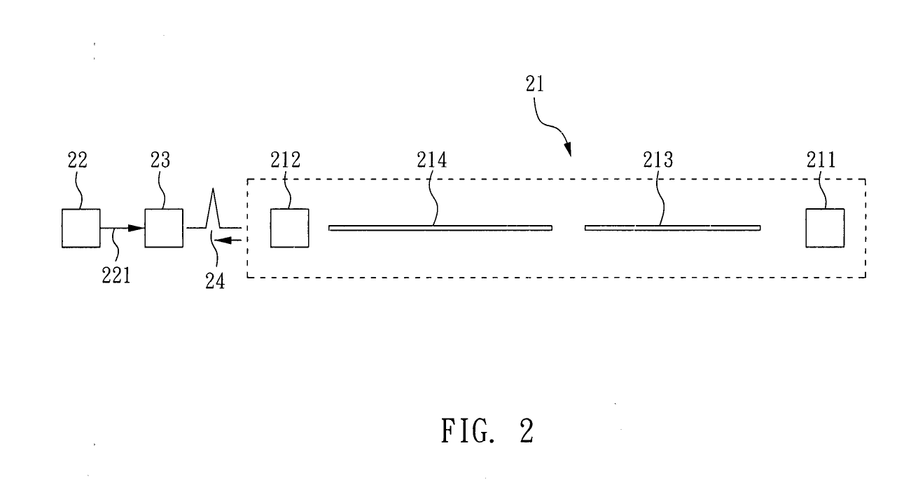

With reference to FIG. 2, which is a perspective view of the pulsed laser system having a Tm³⁺-doped saturable absorber Q-switch unit according to the second embodiment of the present invention. As shown in FIG. 2, the pulsed laser system having a Tm³⁺-doped saturable absorber Q-switch unit according to second embodiment of the present invention comprises: a first laser resonator 21, a pump light source unit 22, and a wavelength multiplexer 23. Wherein, the first laser resonator 21 includes a first reflective component 211, a second reflective component 212, a first gain unit 213 and a Tm³⁺-doped saturable absorber Q-switch unit 214. The pump light source unit 22 is located on one side of the first laser resonator 21, for providing a pump light source 221 into the first laser resonator 21. Besides, the wavelength multiplexer 23 is located between the first laser resonator 21 and the pump light source unit 22.

As shown in FIG. 2, in the first laser resonator 21, the first gain unit 213 and the Tm³⁺-doped saturable absorber Q-switch unit 214 are located between the first reflective component 211 and the second reflective component 212, so that the resonant photons (not shown in the figure) of the first laser resonator 21 could pass through the first gain unit 213 and the Tm³⁺-doped saturable absorber Q-switch unit 214 repeatedly. Moreover, the pulsed laser system having a Tm³⁺-doped saturable absorber Q-switch unit according to the second embodiment of the present invention operating, is excited with the pump light source unit 22 emitting the pump light source 221 that is passing through the wavelength multiplexer 23 and incident into the first laser resonator 21 to create a gain in the first gain unit 213.

While being excited consecutively, the gain of the first gain unit 213 increases with time, and when the gain of the first gain unit 213 exceeds the lasing threshold, the resonant photons (not shown in the figure) are generated and being amplified inside the first laser resonator 21. At this moment, the Tm³⁺-doped saturable absorber Q-switch unit 214 of the first laser resonator 21 absorbs the resonant photons (not shown in the figure) till the Tm³⁺-doped saturable absorber Q-switch unit 214 reaches the situation of absorption saturation (i.e. the Tm³⁺-doped saturable absorber Q-switch unit 214 becomes transparent, or called bleached). Then, a laser pulse 24 is formed from the resonant photons (not shown in the figure) and outputted from the first laser resonator 21.

In the present embodiment, the pump light source unit 22 is a laser diode, capable of providing a stable continuous-wave pump light source 221 with, and the wavelength of the pump light source 221 is around 980 nm. Besides, the first gain unit 213 is an Er³⁺-doped fiber, and the Tm³⁺-doped saturable absorber Q-switch unit 214 is a Tm³⁺-doped fiber. The first reflective component 211 is a fiber Bragg grating component with a high reflectivity (about 100%) and the reflective wavelength thereof is 1570 nm. The second reflective component 212 is also a fiber Bragg grating component, but with a low reflectivity (about 20%) and the reflective wavelength thereof is 1570 nm.

As shown in FIG. 2, the laser pulse 24 is outputted from the second reflective unit 212 side of the first laser resonator 21 of the pulsed laser system having a Tm³⁺-doped saturable absorber Q-switch unit according to the second embodiment of the present invention. Then, the laser pulse 24 passes through the wavelength multiplexer 23, to a pre-determined position for application (not shown in the figure).

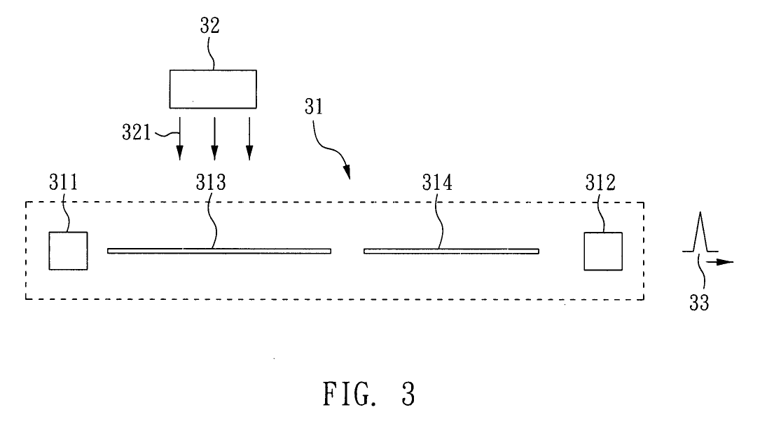

With reference to FIG. 3, which is a perspective view of the pulsed laser system having a Tm³⁺-doped saturable absorber Q-switch unit according to the third embodiment of the present invention. As shown in FIG. 3, the pulsed laser system having a Tm³⁺-doped saturable absorber Q-switch unit according to the third embodiment of the present invention comprises: a first laser resonator 31 and a pump light source unit 32. Wherein, the first laser resonator 31 includes a first reflective component 311, a second reflective component 312, a first gain unit 313 and a Tm³⁺-doped saturable absorber Q-switch unit 314. The pump light source unit 32 is located on one side of the first laser resonator 31, for providing a pump light source 321 into the first laser resonator 31.

Besides, as shown in FIG. 3, in the first laser resonator 31, the first gain unit 313 and the Tm³⁺-doped saturable absorber Q-switch unit 314 are located between the first reflective component 311 and the second reflective component 312, so that the resonant photons (not shown in the figure) of the first laser resonator 31 could pass through the first gain unit 313 and the Tm³⁺-doped saturable absorber Q-switch unit 314 repeatedly. Moreover, the pulsed laser system having a Tm³⁺-doped saturable absorber Q-switch unit according to the third embodiment of the present invention operating, is excited with the pump light source unit 32 emitting the pump light source 321. Thus, the first gain unit 313 is excited to create a gain.

While being excited, the gain of the first gain unit 313 increases with time, and when the gain of the first gain unit 313 exceeds the lasing threshold, the resonant photons (not shown in the figure) are generated and being amplified inside the first laser resonator 31. At this moment, the Tm³⁺-doped saturable absorber Q-switch unit 314 of the first laser resonator 31 absorbs the resonant photons (not shown in the figure) till the Tm³⁺-doped saturable absorber Q-switch unit 314 reaches the situation of absorption saturation (i.e. the Tm³⁺-doped saturable absorber Q-switch unit 314 becomes transparent, or called bleached). Then, a laser pulse 33 is formed from the resonant photons (not shown in the figure) and outputted from the first laser resonator 31.

As described above, the mechanism for producing a laser pulse of the pulsed laser system having a Tm³⁺-doped saturable absorber Q-switch unit according to the third embodiment of the present invention is the same as that of the pulsed laser system having a Tm³⁺-doped saturable absorber Q-switch unit according to the first embodiment of the present invention. However, the differences between these two pulsed laser systems are as follows:

In the pulsed laser system having a Tm³⁺-doped saturable absorber Q-switch unit according to the third embodiment of the present invention, the first gain unit 313 is an Er³⁺-doped crystal, and the Tm³⁺-doped saturable absorber Q-switch unit 314 is a Tm³⁺-doped crystal, rather than Er³⁺-doped fiber and Tm³⁺-doped fiber, respectively. Moreover, the first reflective component 311 and the second reflective component 312 are bulk mirrors, rather than fiber Bragg grating components.

Therefore, the pulsed laser system having a Tm³⁺-doped saturable absorber Q-switch unit according to the third embodiment of the present invention is a conventional bulk pulsed laser system, not the fiber-type pulsed laser system. Besides, the traditional saturable absorber Q-switch crystal materials are U:CaF2, Co:ZnS and Co:ZnSe, etc. However, these crystal materials are difficult both in obtaining and fabricating. As a result, Tm³⁺-doped glass or Tm³⁺-doped crystals can also be used to function as the Tm³⁺-doped saturable absorber Q-switch unit 314. It should be noticed that, the crystal mentioned above usually indicates the bulk-type crystal, such as ruby, YAG and quartz, etc. Since the fiber is made of glass or quartz, the fiber can be categorized as one kind of the crystal mentioned above.

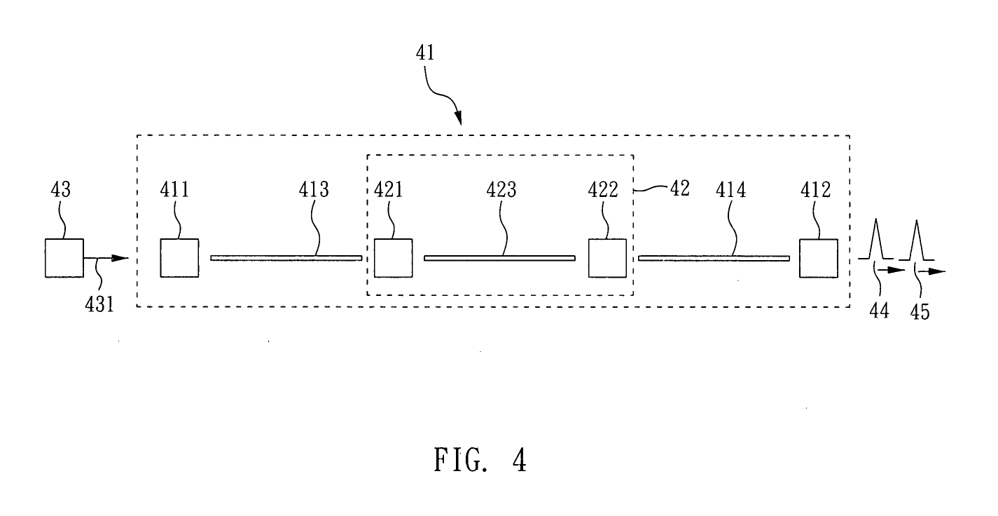

With reference to FIG. 4, which is a perspective view of the pulsed laser system having a Tm³⁺-doped saturable absorber Q-switch unit according to the fourth embodiment of the present invention. As shown in FIG. 4, the pulsed laser system having a Tm³⁺-doped saturable absorber Q-switch unit according to the fourth embodiment of the present invention comprises: a first laser resonator 41, a second laser resonator 42 and a pump light source unit 43. Wherein, the first laser resonator 41 includes a first reflective component 411, a second reflective component 412, a first gain unit 413 and a Tm³⁺-doped saturable absorber Q-switch unit 414, and the first gain unit 413 and the Tm³⁺-doped saturable absorber Q-switch unit 414 are located between the first reflective component 411 and the second reflective component 412.

Besides, the second laser resonator 42 includes a third reflective component 421, a fourth reflective component 422 and a second gain unit 423, wherein the second gain unit 423 is located between the first reflective component 411 and the second reflective component 412, and further between the third reflective component 421 and the fourth reflective component 422. Moreover, the pump light source unit 43 is located on one side of the first laser resonator 41, for providing a pump light source 431 into the first laser resonator 41.

Besides, as described above, in the first laser resonator 41, the first gain unit 413 and the Tm³⁺-doped saturable absorber Q-switch unit 414 are located between the first reflective component 411 and the second reflective component 412, so that the first resonant photons (not shown in the figure) of the first laser resonator 41 could pass through the first gain unit 413 and the Tm³⁺-doped saturable absorber Q-switch unit 414 repeatedly. Moreover, the pulsed laser system having a Tm³⁺-doped saturable absorber Q-switch unit according to the fourth embodiment of the present invention operating, is excited with the pump light source unit 43 emitting the pump light source 431. Thus, the first gain unit 413 is excited to create a gain.

While being excited, the gain of the first gain unit 413 increases with time, and when the gain of the first gain unit 413 exceeds the lasing threshold, the first resonant photons (not shown in the figure) are generated and being amplified inside the first laser resonator 41. At this moment, the Tm³⁺-doped saturable absorber Q-switch unit 414 of the first laser resonator 41 absorbs the first resonant photons (not shown in the figure) till the Tm³⁺-doped saturable absorber Q-switch unit 414 reaches the situation of absorption saturation (i.e. the Tm³⁺-doped saturable absorber Q-switch unit 414 becomes transparent, or called bleached). Then, a first laser pulse 44 is formed from the first resonant photons (not shown in the figure) and outputted from the first laser resonator 41.

At this moment, the second gain unit 423 of the second laser resonator 42 is excited by the first resonant photons (not shown in the figure) and reaches a large gain instantly. When the gain of the second gain unit 423 exceeds the lasing threshold of the second laser resonator 42, the second resonant photons (not shown in the figure) are generated and amplified inside the second laser resonator 42. Then, a second laser pulse 45 is formed from the second resonant photons (not shown in the figure) and outputted from the second laser resonator 42.

In the present embodiment, the pump light source unit 43 is a laser diode, capable of providing a stable continuous-wave pump light source 431, and the wavelength of the pump light source 431 is around 980 nm. Besides, the first gain unit 413 is an Er³⁺-doped fiber, and the Tm³⁺-doped saturable absorber Q-switch unit 414 is a Tm³⁺-doped fiber. The first reflective component 411 is a fiber Bragg grating component with a high reflectivity (about 100%) and the reflective wavelength thereof is 1570 nm. The second reflective component 412 is also a fiber Bragg grating component, but with a low reflectivity (about 20%) and the reflective wavelength thereof is 1570 nm.

Moreover, the second gain unit 423 is a Tm³⁺ and Ho³⁺ co-doped fiber. The third reflective component 421 is a fiber Bragg grating component with a high reflectivity (about 100%) and the reflective wavelength thereof is 1950 nm. The fourth reflective component 422 is also a fiber Bragg grating component, but with a low reflectivity (about 20%) and the reflective wavelength thereof is 1950 nm. The radiative ion of the second laser resonator 42 is Tm³⁺, the wavelength of the second laser pulse 45 is 1950 nm.

Therefore, the pulsed laser system having a Tm³⁺-doped saturable absorber Q-switch unit according to the fourth embodiment of the present invention is also called a gain-switched Tm³⁺ laser.

As shown in FIG. 4, the first laser pulse 44 and the second laser pulse 45 are both outputted from the second reflective unit 412 side of the first laser resonator 41 of the pulsed laser system having a Tm³⁺-doped saturable absorber Q-switch unit according to the fourth embodiment of the present invention.

Afterward, after the second laser pulse 45 is outputted, the Tm³⁺-doped saturable absorber Q-switch unit 414 instantly returns back to the initial condition in which the Tm³⁺-doped saturable absorber Q-switch unit 414 can absorb the first resonant photons (not shown in the figure) in the first laser resonator 41 once again. After that, Tm³⁺ doped fiber being designated as the Tm³⁺-doped saturable absorber Q-switch unit 414 repeats the aforementioned process (to reach an absorption saturation situation once again), making the pulsed laser system having a Tm³⁺-doped saturable absorber Q-switch unit according to the fourth embodiment of the present invention to output the another first laser pulse 44 and the second laser pulse 45.

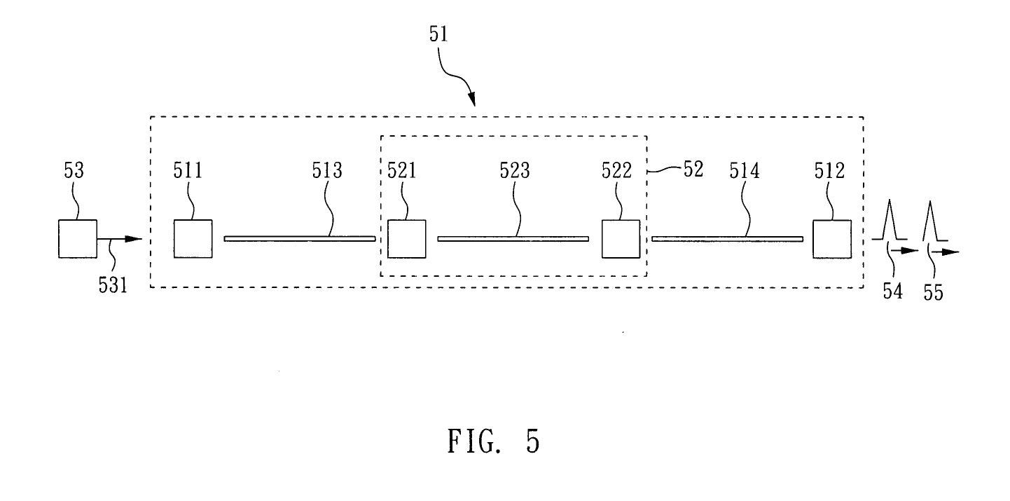

With reference to FIG. 5, which is a perspective view of the pulsed laser system having a Tm³⁺-doped saturable absorber Q-switch unit according to the fifth embodiment of the present invention. As shown in FIG. 5, the pulsed laser system having a Tm³⁺-doped saturable absorber Q-switch unit according to the fifth embodiment of the present invention comprises: a first laser resonator 51, a second laser resonator 52 and a pump light source unit 53. Wherein, the first laser resonator 51 includes a first reflective component 511, a second reflective component 512, a first gain unit 513 and a Tm³⁺-doped saturable absorber Q-switch unit 514, and the first gain unit 513 and the Tm³⁺-doped saturable absorber Q-switch unit 514 are located between the first reflective component 511 and the second reflective component 512.

Besides, the second laser resonator 52 includes a third reflective component 521, a fourth reflective component 522 and a second gain unit 523, wherein the second gain unit 523 is located between the first reflective component 511 and the second reflective component 512, and further between the third reflective component 521 and the fourth reflective component 522. Moreover, the pump light source unit 53 is located on one side of the first laser resonator 51, for providing a pump light source 531 into the first laser resonator 51.

As described above, the mechanism for producing the first laser pulse 54 and the second laser pulse 55 of the pulsed laser system having a Tm³⁺-doped saturable absorber Q-switch unit according to the fifth embodiment of the present invention are the same as those of the pulsed laser system having a Tm³⁺-doped saturable absorber Q-switch unit according to the fourth embodiment of the present invention. However, the differences between these two pulsed laser systems are as follows:
1. In the pulsed laser system having a Tm³⁺-doped saturable absorber Q-switch unit according to the fourth embodiment of the present invention, the central reflection wavelength of the third reflective component 421 and the fourth reflective component 422 are 1950 nm, and the radiative ion of the second laser resonator 42 is Tm³⁺; and
2. In the pulsed laser system having a Tm³⁺-doped saturable absorber Q-switch unit according to the fifth embodiment of the present invention, the central reflection wavelength of the third reflective component 521 and the fourth reflective component 522 are 2090 nm, and the radiative ion of the second laser resonator 52 is Ho³⁺.

Therefore, the pulsed laser system having a Tm³⁺-doped saturable absorber Q-switch unit according to the fifth embodiment of the present invention is so-called gain-switched Ho³⁺ laser.

As shown in FIG. 5, the first laser pulse 54 and the second laser pulse 55 are both outputted from the second reflective unit 512 side of the first laser resonator 51 of the pulsed laser system having a Tm³⁺-doped saturable absorber Q-switch unit according to the fifth embodiment of the present invention.

Afterward, after the second laser pulse 55 is outputted, the Tm³⁺-doped saturable absorber Q-switch unit 514 instantly returns back to the initial condition in which the Tm³⁺-doped saturable absorber Q-switch unit 514 can absorb the first resonant photons (not shown in the figure) in the first laser resonator 51 once again. After that, Tm³⁺ doped fiber being designated as the Tm³⁺-doped saturable absorber Q-switch unit 514 repeats the aforementioned process (to reach an absorption saturation situation once again), making the pulsed laser system having a Tm³⁺-doped saturable absorber Q-switch unit according to the fifth embodiment of the present invention to output the another first laser pulse 54 and the second laser pulse 55.

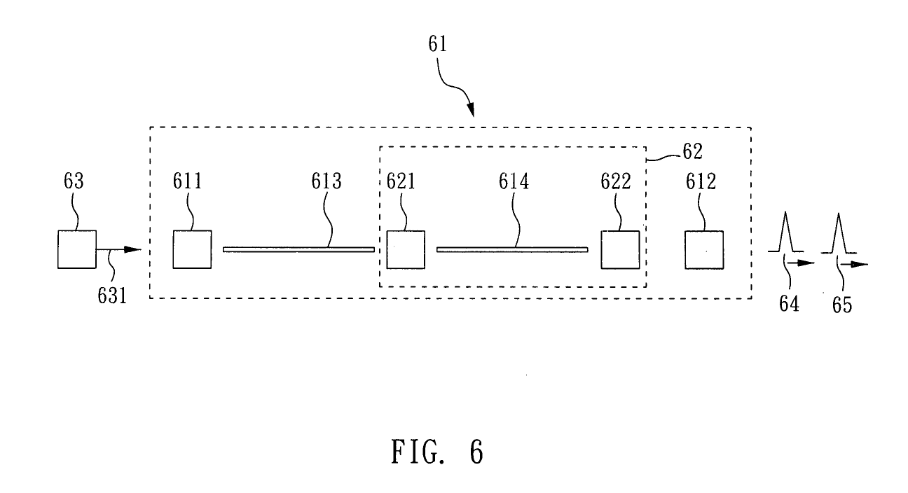

With reference to FIG. 6, which is a perspective view of the pulsed laser system having a Tm³⁺-doped saturable absorber Q-switch unit according to the sixth embodiment of the present invention. As shown in FIG. 6, the pulsed laser system having a Tm³⁺-doped saturable absorber Q-switch unit according to the sixth embodiment of the present invention comprises: a first laser resonator 61, a second laser resonator 62 and a pump light source unit 63. Wherein, the first laser resonator 61 includes a first reflective component 611, a second reflective component 612, a first gain unit 613 and a Tm³⁺-doped saturable absorber Q-switch unit 614, and the first gain unit 613 and the Tm³⁺-doped saturable absorber Q-switch unit 614 are located between the first reflective component 611 and the second reflective component 612.

Besides, the second laser resonator 62 includes a third reflective component 621, and a fourth reflective component 622, wherein the Tm³⁺-doped saturable absorber Q-switch unit 614 is located between the third reflective component 621 and the fourth reflective component 622. Moreover, the Tm³⁺-doped saturable absorber Q-switch unit 614 is also functioning as a gain unit of the second laser resonator 62. The pump light source unit 63 is located on one side of the first laser resonator 61, for providing a pump light source 631 into the first laser resonator 61.

Besides, as described above, in the first laser resonator 61, the first gain unit 613 and the Tm³⁺-doped saturable absorber Q-switch unit 614 are located between the first reflective component 611 and the second reflective component 612, so that the first resonant (not shown in the figure) of the first, laser resonator 61 could pass through the first gain unit 613 and the Tm³⁺-doped saturable absorber Q-switch unit 614 repeatedly. Moreover, the pulsed laser system having a Tm³⁺-doped saturable absorber Q-switch unit according to the sixth embodiment of the present invention operating, is excited with the pump light source unit 63 emitting the pump light source 631 to create a gain.

While being excited, the gain of the first gain unit 613 increases with time, and when the gain of the first gain unit 613 exceeds the lasing threshold, the first resonant photons (not shown in the figure) are generated and being amplified inside the first laser resonator 61. At this moment, the Tm³⁺-doped saturable absorber Q-switch unit 614 of the first laser resonator 61 absorbs the first resonant photons (not shown in the figure) till the Tm³⁺-doped saturable absorber Q-switch unit 614 reaches the situation of absorption saturation (i.e. the Tm³⁺-doped saturable absorber Q-switch unit 614 becomes transparent, or called bleached). Then, a first laser pulse 64 is formed from the first resonant photons (not shown in the figure) and outputted from the first laser resonator 61.

At this moment, the Tm³⁺-doped saturable absorber Q-switch unit 614 functioning as the gain unit of the second laser resonator 62, is excited by the first resonant photons (not shown in the figure) and reaches a large gain instantly. When the gain of the Tm³⁺-doped saturable absorber Q-switch unit 614 exceeds the lasing threshold of the second laser resonator 62, the second resonant photons (not shown in the figure) are generated and amplified inside the second laser resonator 62. Then, a second laser pulse 65 is formed from the second resonant photons (not shown in the figure) and outputted from the second laser resonator 62.

In the present embodiment, the pump light source unit 63 is a laser diode, capable of providing a stable continuous-wave pump light source 631, and the wavelength of the pump light source 631 is around 980 nm. Besides, the first gain unit 613 is an Er³⁺-doped fiber, and the Tm³⁺-doped saturable absorber Q-switch unit 614 is a Tm³⁺-doped or a Tm³⁺ and Ho³⁺ co-doped fiber. The first reflective component 611 is a fiber Bragg grating component with a high reflectivity (about 100%) and the reflective wavelength thereof is 1570 nm. The second reflective component 612 is also a fiber Bragg grating component, but with a low reflectivity (about 20%) and the reflective wavelength thereof is 1570 nm.

Moreover, the third reflective component 621 is a fiber Bragg grating component with a high reflectivity (about 100%) and the reflective wavelength thereof is 1950 nm. The fourth reflective component 622 is also a fiber Bragg grating component, but with a low reflectivity (about 20%) and the reflective wavelength thereof is 1950 nm. The radiative ion of the second laser resonator 62 is Tm³⁺, the wavelength of the second laser pulse 65 is 1950 nm.

Therefore, the pulsed laser system having a Tm³⁺-doped saturable absorber Q-switch unit according to the sixth embodiment of the present invention is also called gain-switched Tm³⁺ laser.

As shown in FIG. 6, the first laser pulse 64 and the second laser pulse 65 are both outputted from the second reflective unit 612 side of the first laser resonator 61 of the pulsed laser system having a Tm³⁺-doped saturable absorber Q-switch unit according to the sixth embodiment of the present invention.

Afterward, after the second laser pulse 65 is outputted, the Tm³⁺-doped saturable absorber Q-switch unit 614 instantly returns back to the initial condition in which the Tm³⁺-doped saturable absorber Q-switch unit 614 can absorb the first resonant photons (not shown in the figure) in the first laser resonator 61 once again. After that, Tm³⁺ and Ho³⁺ co-doped fiber being designated as the Tm³⁺-doped saturable absorber Q-switch unit 614 repeats the aforementioned process (to reach an absorption saturation situation once again), making the pulsed laser system having a Tm³⁺-doped saturable absorber Q-switch unit according to the sixth embodiment of the present invention to output the another first laser pulse 64 and the second laser pulse 65.

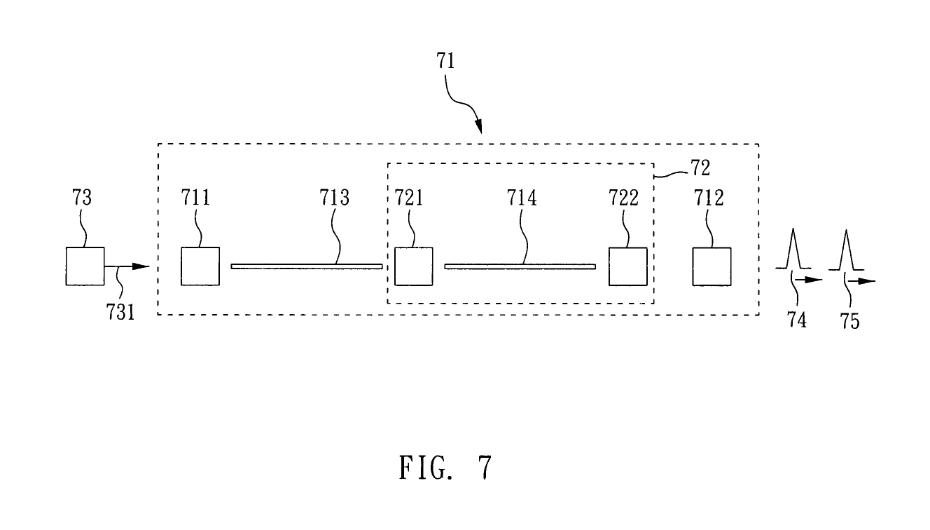

With reference to FIG. 7, which is a perspective view of the pulsed laser system having a Tm³⁺-doped saturable absorber Q-switch unit according to the seventh embodiment of the present invention. As shown in FIG. 7, the pulsed laser system having a Tm³⁺-doped saturable absorber Q-switch unit according to the seventh embodiment of the present invention comprises: a first laser resonator 71, a second laser resonator 72 and a pump light source unit 73. Wherein, the first laser resonator 71 includes a first reflective component 711, a second reflective component 712, a first gain unit 713 and a Tm³⁺-doped saturable absorber Q-switch unit 714, and the first gain unit 713 and the Tm³⁺-doped saturable absorber Q-switch unit 714 are located between the first reflective component 711 and the second reflective component 712.

Besides, the second laser resonator 72 includes a third reflective component 721, and a fourth reflective component 722, wherein the Tm³⁺-doped saturable absorber Q-switch unit 714 is located between the third reflective component 721 and the fourth reflective component 722. Moreover, the Tm³⁺-doped saturable absorber Q-switch unit 714 is also functioning as a gain unit of the second laser resonator 72. The pump light source unit 73 is located on one side of the first laser resonator 71, for providing a pump light source 731 into the first laser resonator 71.

As described above, the mechanism for producing the first laser pulse 74 and the second laser pulse 75 of the pulsed laser system having a Tm³⁺-doped saturable absorber Q-switch unit according to the seventh embodiment of the present invention are the same as those of the pulsed laser system having a Tm³⁺-doped saturable absorber Q-switch unit according to the sixth embodiment of the present invention. However, the differences between these two pulsed laser systems are as follows:
1. In the pulsed laser system having a Tm³⁺-doped saturable absorber Q-switch unit according to the sixth embodiment of the present invention, the reflective wavelength of the third reflective component 621 and the fourth reflective component 622 are at 1950 nm, and the radiative ion of the second laser resonator 62 is Tm³⁺; and
2. In the pulsed laser system having a Tm³⁺-doped saturable absorber Q-switch unit according to the seventh embodiment of the present invention, the reflective wavelength of the third reflective component 721 and the fourth reflective component 722 are at 2090 nm, and the radiative ion of the second laser resonator 52 is Ho³⁺.

As shown in FIG. 7, the first laser pulse 74 and the second laser pulse 75 are both outputted from the second reflective unit 712 side of the first laser resonator 71 of the pulsed laser system having a Tm³⁺-doped saturable absorber Q-switch unit according to the seventh embodiment of the present invention.

Afterward, after the second laser pulse 75 is outputted, the Tm³⁺-doped saturable absorber Q-switch unit 714 instantly returns back to the initial condition in which the Tm³⁺-doped saturable absorber Q-switch unit 714 can absorb the first resonant photons (not shown in the figure) in the first laser resonator 71 once again. After that, Tm³⁺ and Ho³⁺ co-doped fiber being designated as the Tm³⁺-doped saturable absorber Q-switch unit 714 repeats the aforementioned process (to reach an absorption saturation situation once again), making the pulsed laser system having a Tm³⁺-doped saturable absorber Q-switch unit according to the seventh embodiment of the present invention to produce the another first laser pulse 74 and the second laser pulse 75.

In conclusion, due to the first laser resonator of the pulsed laser system having a Tm³⁺-doped saturable absorber Q-switch unit of the present invention comprises a Tm³⁺-doped saturable absorber Q-switch unit, and the Q-switching criterion is satisfied by the properties of the first gain unit and the Tm³⁺-doped saturable absorber Q-switch unit at the resonant wavelength of the first laser resonator determined by the first and the second reflective units, the pulsed laser system having a Tm³⁺-doped saturable absorber Q-switch unit of the present invention can successively produce Q-switched pulses while being pumped with a stable continuous-wave light source.

Besides, due to the first resonant photon generated in the first laser resonator can excite the second gain unit of the second laser resonator and make the second gain unit to reach a gain, thus, the pulsed laser system having a Tm³⁺-doped saturable absorber Q-switch unit of the present invention can successively produce gain-switched pulses while being pumped with a stable continuous-wave light source.

Although the present invention has been explained in relation to its preferred embodiments, it is to be understood that many other possible modifications and variations can be made without departing from the scope of the invention as hereinafter claimed.

What is claimed is:

1. A pulsed laser system having a Tm³⁺-doped saturable absorber Q-switch unit comprising:
a first laser resonator including a first reflective component, a second reflective component, a first gain unit and a Tm³⁺-doped saturable absorber Q-switch unit, with the first gain unit and the Tm³⁺-doped saturable absorber Q-switch unit located between the first reflective unit and the second reflective unit; and
a pump light source unit, located on one side of the first laser resonator and providing a pump light source into the first laser resonator;
wherein, while the pump light source is incident into the first laser resonator, the first gain unit is excited to reach a gain, when the gain of the first gain unit exceeds the lasing threshold, the resonant photons are generated and being amplified inside the first laser resonator, the Tm³⁺-doped saturable absorber Q-switch unit absorbs the resonant photons till the Tm³⁺-doped saturable absorber Q-switch unit reaches the situation of absorption saturation; a laser pulse is formed from the resonant photons and outputted from the first laser resonator.

2. The pulsed laser system having a Tm³⁺-doped saturable absorber Q-switch unit as claimed in claim 1, wherein the first gain unit is an Er³⁺ doped fiber and the Tm³⁺-doped saturable absorber Q-switch unit is a Tm³⁺ doped fiber.

3. The pulsed laser system having a Tm³⁺-doped saturable absorber Q-switch unit as claimed in claim 1, wherein the first reflective component is a fiber Bragg grating component with a high reflectivity, the second reflective component is a fiber Bragg grating component with a low reflectivity.

4. The pulsed laser system having a Tm³⁺-doped saturable absorber Q-switch unit as claimed in claim 1, further includes a wavelength multiplexer, the wavelength multiplexer is located between the first laser resonator and the pump light source unit to separate the pump light source and the laser pulses, and to protect the pump light source unit from being damaged by the laser pulses.

5. The pulsed laser system having a Tm³⁺-doped saturable absorber Q-switch unit as claimed in claim 1, wherein the first gain unit is further co-doped with ytterbium or other heterogeneous dopants, for enhancing the gain property thereof.

6. The pulsed laser system having a Tm³⁺-doped saturable absorber Q-switch unit as claimed in claim 1, wherein the Tm³⁺-doped saturable absorber Q-switch unit is further co-doped with aluminum, phosphorous, or other heterogeneous dopants, for enhancing the saturation absorption property thereof.

7. The pulsed laser system having a Tm³⁺-doped saturable absorber Q-switch unit as claimed in claim 1, wherein the wavelength of the laser pulse is between 1500 nm to 1620 nm.

8. A pulsed laser system having a Tm³⁺-doped saturable absorber Q-switch unit comprising:
a first laser resonator including a first reflective component, a second reflective component, a first gain unit and a Tm³⁺-doped saturable absorber Q-switch unit, with the first gain unit and the Tm³⁺-doped saturable absorber Q-switch unit located between the first reflective unit and the second reflective unit;
a second laser resonator including a third reflective component, a fourth reflective component and a second gain unit, with the second gain unit located between the first reflective component and the second reflective component, and between the third reflective component and the fourth reflective component; and
a pump light source unit located on one side of the first laser resonator and providing a pump light source into the first laser resonator;
wherein, while the pump light source is incident into the first laser resonator, the first gain unit is excited to reach a gain, when the gain of the first gain unit exceeds the lasing threshold of the first laser resonator, the first resonant photons are generated and amplified inside the first laser resonator, the Tm³⁺-doped saturable absorber Q-switch unit absorbs the first resonant photons till the Tm³⁺-doped saturable absorber Q-switch unit reaches the situation of absorption saturation; a first laser pulse is formed from the first resonant photons and outputted from the first laser resonator; the second gain unit is excited by the first resonant photons and reaches a gain, and when the gain of the second gain unit exceeds the lasing threshold of the second laser resonator, the second resonant photons are generated and amplified inside the second laser resonator, a second laser pulse is formed from the second resonant photons and outputted from the second laser resonator.

9. The pulsed laser system having a Tm³⁺-doped saturable absorber Q-switch unit as claimed in claim 8, wherein the second gain unit is a Tm³⁺ and Ho³⁺ co-doped fiber.

10. The pulsed laser system having a Tm³⁺-doped saturable absorber Q-switch unit as claimed in claim 9, wherein the first reflective component and the second reflective component are fiber Bragg grating components with the reflective wavelength of 1570 nm, the third reflective component and the fourth reflective component are fiber Bragg grating components with the reflective wavelength of 1950 nm, the radiative ion of the second laser resonator is Tm³⁺, the wavelength of the second laser pulse is 1950 nm.

11. The pulsed laser system having a Tm³⁺-doped saturable absorber Q-switch unit as claimed in claim 9, wherein the first reflective component and the second reflective component are fiber Bragg grating components with the reflective wavelength of 1570 nm, the third reflective component and the fourth reflective component are fiber Bragg grating components with the reflective wavelength of 2090 nm, the radiative ion of the second laser resonator is Ho³⁺, the wavelength of the second laser pulse is 2090 nm.

12. A pulsed laser system having a Tm³⁺-doped saturable absorber Q-switch unit comprising:
a first laser resonator including a first reflective component, a second reflective component, a first gain unit and a Tm³⁺-doped saturable absorber Q-switch unit, with the first gain unit and the Tm³⁺-doped saturable absorber Q-switch unit located between the first reflective unit and the second reflective unit;
a second laser resonator including a third reflective component and a fourth reflective component, with the Tm³⁺-doped saturable absorber Q-switch unit located between the third reflective component and the fourth reflective component, the Tm³⁺-doped saturable absorber Q-switch unit is functioning as a gain unit in the second laser resonator; and
a pump light source unit located on one side of the first laser resonator and providing a pump light source into the first laser resonator;
wherein, while the pump light source is incident into the first laser resonator, the first gain unit is excited to reach a gain, when the gain of the first gain unit exceeds the lasing threshold of the first laser resonator, the first resonant photons are generated and amplified inside the first laser resonator, the Tm³⁺-doped saturable absorber Q-switch unit absorbs the first resonant photons till the Tm³⁺-doped saturable absorber Q-switch unit reaches the situation of absorption saturation; a first laser pulse is formed from the first resonant photons and outputted from the first laser resonator; the Tm³⁺-doped saturable absorber Q-switch unit is also exited by the first resonant photons and reaches a gain, and when the gain of the Tm³⁺-doped saturable absorber Q-switch unit exceeds the lasing threshold of the second laser resonator, the second resonant photons are generated and amplified inside the second laser resonator, a second laser pulse is formed from the second resonant photons and outputted from the second laser resonator.

13. The pulsed laser system having a Tm³⁺-doped saturable absorber Q-switch unit as claimed in claim 12, wherein the Tm³⁺-doped saturable absorber Q-switch unit is a Tm³⁺ and Ho³⁺ co-doped fiber.

14. The pulsed laser system having a Tm³⁺-doped saturable absorber Q-switch unit as claimed in claim 13, wherein the first reflective component and the second reflective component are fiber Bragg grating components with the reflective wavelength of 1570 nm, the third reflective component and the fourth reflective component are fiber Bragg grating components with the reflective wavelength of 1950 nm, the radiative ion of the second laser resonator is Tm³⁺, the wavelength of the second laser pulse is 1950 nm.

15. The pulsed laser system having a Tm³⁺-doped saturable absorber Q-switch unit as claimed in claim 13, wherein the first reflective component and the second reflective component are fiber Bragg grating components with the reflective wavelength of 1570 nm, the third reflective component and the fourth reflective component are fiber Bragg grating components with the reflective wavelength of 2090 nm, the radiative ion of the second laser resonator is Ho³⁺, the wavelength of the second laser pulse is 2090 nm.
